(19) United States
(12) Patent Application Publication
(10) Pub. No.: US 2005/0023312 A1
(43) Pub. Date: Feb. 3, 2005

(54) Cargo restraint and storage device and method

(76) Inventor: Judith Lynn Steinberg, Hermosa Beach, CA (US)

Correspondence Address: Min (Amy) S. Xu;DORSEY & WHITNEY LLP, Intellectual Property Department, 50 South Sixth Street, Suite 1500, Minneapolis, MN, 55402-1498, US

(21) Appl. No.: 10/879,962

(22) Filed: Jun. 29, 2004

Related U.S. Application Data
(60) Provisional application No. 60/491,714, filed on Aug. 1, 2003.

(51) Int. Cl. B60R 7/00

(52) U.S. Cl. 224/275

(57) ABSTRACT

A cargo restraint and storage device is provided for restraining and storing cargo items placed onto a front passenger seat of a vehicle, thereby restraining the cargo items from flying out of the passenger seat or shifting dangerously when a vehicle is in motion, particularly in a sudden stop or a sharp turn. In one embodiment, a cargo restraint and storage device includes a piece of flexible material having an opening for receiving at least a portion of a seat back section of a front passenger seat. The piece of flexible material has a plurality of pockets with different shapes and sizes for storing varying shapes and sizes of cargo items, thereby restraining the cargo items from flying out of the front passenger seat when a vehicle is in motion, and being accessible to a driver of the vehicle.

### CROSS-REFERENCE TO RELATED APPLICATION(S)

The present utility patent application claims priority of U.S. Provisional Patent Application Ser. No. 60/491,714, filed Aug. 1, 2003; subject matter of which is incorporated herewith by reference.

### FIELD OF THE INVENTION

The present invention generally relates to a cargo restraint and storage device. More particularly, the present invention relates to a cargo restraint and storage device which is configured and arranged to and removable from a support structure readily accessible to a driver of a moving vehicle.

### BACKGROUND OF THE INVENTION

An empty passenger seat in a vehicle is often used as a place to temporarily place or store cargo for a driver which may be required in the course of travel. In the past, when a moving vehicle is required to make a sudden stop or turn sharply, the laws of momentum, gravity, and/or centrifugal force cause the cargo loosely placed or stored on the seat to shift suddenly, being thrown to the floor or side(s) of the seat. The driver of the moving vehicle usually reaches over, instinctively, to catch the shifting cargo as the usual means of restraining it, creating a dangerous traffic hazard.

Passenger seat cargo restraints are known which offer restraint and storage of smaller items, but they usually do not offer adequate space for relatively larger cargo items, such as a woman's purse, an oversized water bottle, office files, etc., for example, “Vehicle Backseat Organizer” as disclosed in U.S. Pat. No. Des. 419,520 by James Allen Bergh or U.S. Pat. No. 1,653,246, issued on Dec. 20, 1927. Other known seat cargo restraint and storage devices employ strap and buckle mechanisms which make it more complicated and inconvenient to remove the devices from a passenger seat when the devices are not needed, for example, “The Seat Caddy” device by Lewis N. Clark Model 8824. Also, many known cargo restraint and storage devices are made of a hard material which must be removed before a passenger can utilize the passenger seat for travel, for example, the “Spillmaster” device by Hopkins Manufacturer as disclosed in U.S. Pat. No. 5,149,032. In addition, some known cargo stowage devices require retaining buttons or fixed objects integral with a vehicle, for example, the devices as disclosed in U.S. Pat. No. 6,334,562 B1 and U.S. Pat. No. 5,340,004 (Re. 36,345). No device is known which would safely restrain larger temporary cargo, such as a woman's purse, onto a passenger seat, particularly a freestanding, bucket-type passenger seat, in a moving vehicle by means of a soft, flexible material with tensile support at the top and bottom horizontal edges, would provide simple implementation and removal, or would adapt itself easily to a passenger utilizing the passenger seat without the device being removed, particularly when most cargos are emptied from the device.

Therefore, there is a need for an improved cargo restraint and storage device which safely restrains cargo on a passenger seat.

### SUMMARY OF THE INVENTION

The present invention provides an improved cargo restraint and storage device which safely restrains and stores a cargo item placed onto a front passenger seat.

In one embodiment, the present invention provides an improved device for use in safely restraining and storing larger cargo items placed onto a free-standing, bucket-type passenger seat, thereby restraining stored/restrained cargo items from flying out of the passenger seat or shifting dangerously when a vehicle is in motion, particularly a sudden stop or a sharp turn.

In one embodiment, a cargo restraint and storage device, in accordance with the principles of the present invention, is configured and arranged to slide over and onto a free-standing, bucket-type passenger seat. The passenger seat has a seat section and a seat back section. The cargo restraint and storage device is configured and arranged to slide over and onto the seat back section of the passenger seat. A user can pull the bottom edge of the device down over the seat back section until the device is placed around the seat back section. The device is circumferentially in place onto the seat back section of a free-standing, bucket-type passenger seat.

In one embodiment, a cargo restraint and storage device, in accordance with the principles of the present invention, is made of a flexible material in a simple and inexpensive construction. Accordingly, a passenger is able to sit or lean back on the seat back section comfortably, particularly when cargo items are emptied from the device. Also, the device can easily be put in place and removed from the seat back section.

The term “flexible material” used in the present invention generally refers to as a soft textile material or equivalent or suitable materials thereof, for example, a fabric material. In one embodiment of the present invention, the flexible material is a soft, lightweight, fabric material, Other exemplary materials can be, but not limited to, plastic flat structures or netting. Such soft, flexible, lightweight material can also be transported easily. The term “lightweight” used in the present invention generally refers to as a type of material that is suitable for being easily transported, for example, 8.5 oz or less, etc.

The present invention also provides a method of restraining and storing cargo items in a cargo restraint and storage device to prevent cargo items from flying out of a passenger seat or shifting dangerously when a vehicle is in motion, particularly in a sudden stop or a sharp turn.

Thus, one of the advantages of the present invention is that the device provides strength and restraint of varying shapes and sizes of cargo items onto a support structure, such as a front passenger seat of a vehicle.

Another advantage of the present invention is that the device allows safe, quick and easy access to a cargo item while driving.

A further advantage of the present invention is that the device can be left in place when a passenger uses the front passenger seat.

The foregoing features and/or advantages can be accomplished by providing a cargo restraint and storage device, in one embodiment, having a wall-shaped piece of fabric with an elasticized opening section at the top of the device which is stretchable horizontally, and an elasticized opening section at the bottom of the device which is also stretchable horizontally. The piece of fabric has a longitudinal opening extending from the top of the device to the bottom of the device. The device pulls over or wraps around and abuts a support structure, such as a back-rest or seat back section of a typical free-standing, bucket-type seat, and is held in place against the support structure with tensile stress.

In one embodiment, a user pulls the device over the support structure by manually stretching a bottom edge of the device and pulling the device down onto the support structure along the longitudinal opening of the device. When the user releases the bottom edge of the device, the tensile stress helps tighten the device onto the support structure. The cargo items, such as a purse, files, water bottle, cell phones, PDA devices, note pads, pens/pencils, etc., can be stored in various pockets of the device. The cargo items within the pockets are thus restrained from flying out and/or shifting dangerously when a vehicle makes a sudden stop or sharp turn.

In one embodiment, the various pockets can be in different sizes located on the outside body of the device. The locations of the pockets can be varied. In one embodiment, the pockets can be designed to be open on the same horizontal top side. The pockets can be constructed of textile, plastic, netting, or a cold/heat retaining material.

Variations of the device include proportionately larger pieces of material to create a device which would accommodate various sized (circumferentially) seat-back of the support structure.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a perspective view of one embodiment of a cargo restraint and storage device in accordance with the principles of the present invention.

FIG. 2 is a perspective view of one embodiment of a cargo restraint and storage device having a wall-shaped piece of material forming a longitudinal opening for sliding over and onto a support structure, in accordance with the principles of the present invention.

FIG. 3a is an elevation view of an interior side of a flattened wall-shaped piece of material of FIG. 2 showing horizontally stretchable top and bottom edges, in accordance with the principles of the present invention.

FIG. 3b is a partial view of a folded-over seam allowance at one corner of the material of FIG. 3a.

FIG. 3c is a partial view of an elastic being sewn into the folded-over seam allowance at one corner of the material of FIG. 3b.

FIG. 4 is an elevation view of an exterior side of a flattened wall-shaped piece of material showing fabric gathering lines of one embodiment of the cargo restraint and storage device, in accordance with the principles of the present invention.

FIG. 5 is an elevation view of an interior side of the wall-shaped piece of material showing a joining seam of one embodiment of the cargo restraint and storage device, in accordance with the principles of the present invention.

### DETAILED DESCRIPTION

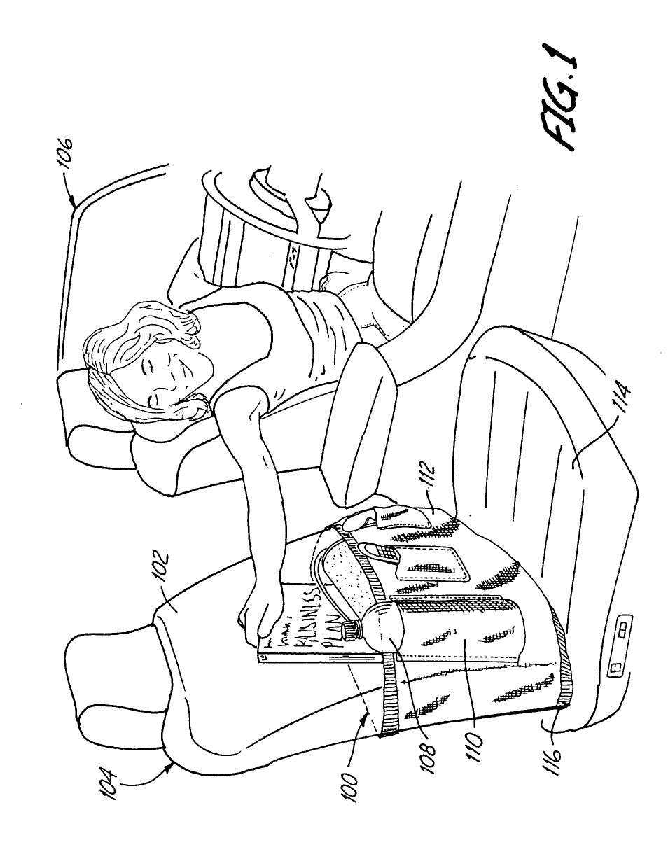

FIG. 1 illustrates one embodiment of a cargo restraint and storage device 100 that can be slid over and onto a support structure, such as a seat back section 102 of a free-standing, bucket-type passenger seat 104 of a vehicle 106. Cargo items 108 can be stored in various pockets 110 that are disposed on an outside wall 112 of the device 100. The cargo items 108 are restrained in the pockets 110 and refrained from flying out of the passenger seat 104 or shifting dangerously when the vehicle 106 is in motion, particularly in a sudden stop or a sharp turn. The cargo items 108 may include, but not limited to, a purse, file, paper, bottle, cell phone, PDA device, note pad, pen/pencil, etc.

As shown in FIG. 1, the cargo restraint and storage device 100 is configured and arranged to slide over and onto the free-standing, bucket-type passenger seat 104. The passenger seat 104 has a seat section 114 and the seat back section 102. The seat section 114 and the seat back section 102 are pivotally attached to each other at a junction 116. A user can pull the device 100 over the seat back section 102 until the device 100 is placed around the seat back section 102 proximate the seat section 114 at the junction 116. Accordingly, the device 100 is circumferentially in place onto the seat back section 102 of the free-standing, bucket-type passenger seat 104.

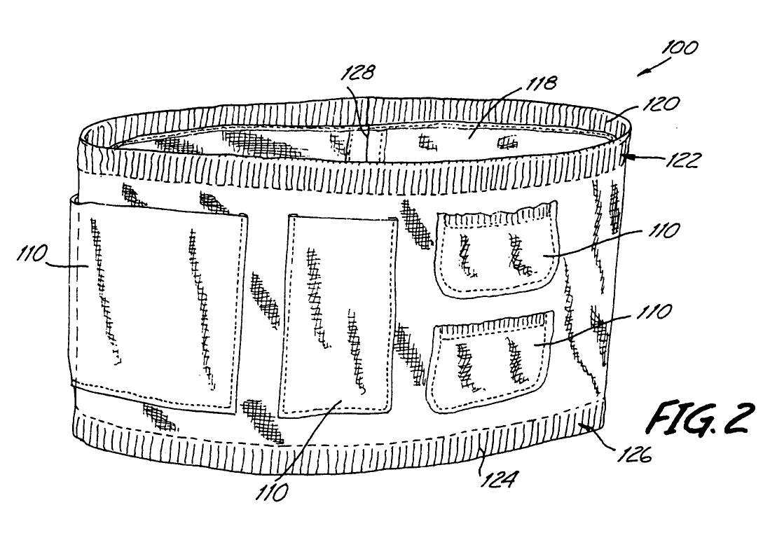

FIG. 2 shows one embodiment of the cargo restraint and storage device 100 having a wall-shaped piece of material forming a longitudinal opening 118 for sliding over and onto a support structure, such as the seat back section 102 of the passenger seat 104 as shown in FIG. 1. In one embodiment, the cargo restraint and storage device 100 is made of a flexible material in a simple and inexpensive construction such that a passenger of the vehicle 106 is able to sit or lean back on the seat back section 102 comfortably, with or without the cargo items 108 being emptied from the device 100. The device 100 can easily be put in place and removed from the seat back section 102 if desired.

The flexible material of the device 100 may be made of a soft, flexible, lightweight textile, or any other suitable materials, such as plastic flat structures or netting. Such soft, flexible, lightweight material provides strength and restraint against the forward and sideways thrust of the cargo items contained therein, while offering the flexibility necessary to accommodate varying shapes and sizes of the cargo items. Further, the soft, flexible, lightweight material can be transported easily.

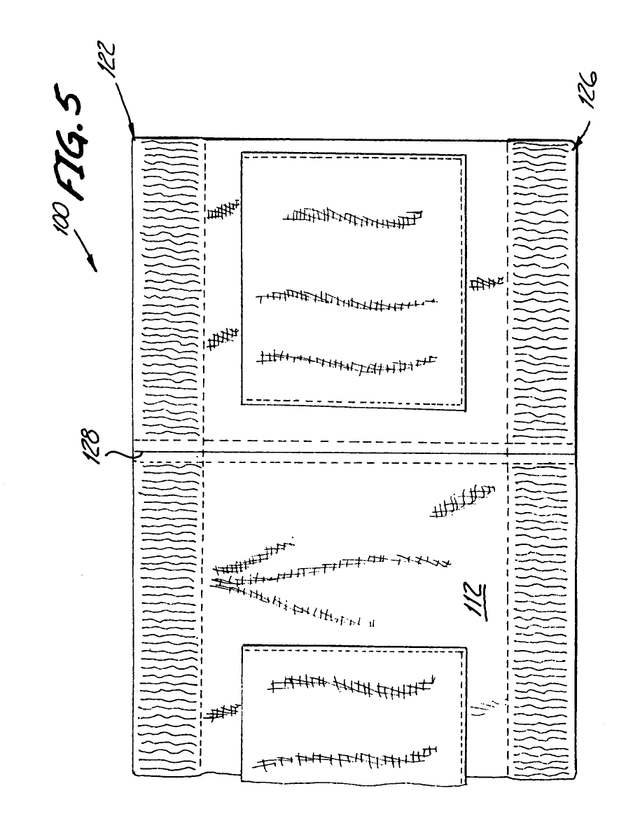

In one embodiment, the device 100 is a wall-shaped piece of fabric with an elasticized opening section 120 at a top 122 of the device 100 which is stretchable horizontally, and an elasticized opening section 124 at a bottom 126 of the device 100 which is also stretchable horizontally. The fabric material is wrapped around and sewn along a joining seam 128 (see details below in FIG. 5) which forms the longitudinal opening 118 extending from the top 122 of the device 100 to the bottom 126 of the device 100. The device 100 can be wrapped around the passenger seat 104 and is held in place against the passenger seat 104 with tensile stress. Accordingly, a user pulls the device 100 over and onto the passenger seat 104 by manually stretching the bottom 126 of the device 100 and pulling the device 100 down onto the passenger seat 104 along the longitudinal opening 118 of the device 100. When the user releases the bottom 126 of the device 100, the tensile stress helps tighten the device 100 onto the passenger seat 104.

In FIG. 2, the various pockets 110 can be in different sizes located on the outside wall 112 of the device 100. The locations of the pockets 110 can be varied. In one embodiment, the pockets 110 can be designed to be open on the same horizontal top side. The pockets 110 can be constructed of textile, plastic, netting, or a cold/heat retaining material.

It will be appreciated that variations of the device 100 may include proportionately larger pieces of material to form the device which accommodates various sized (circumferentially) seat-back of a passenger seat.

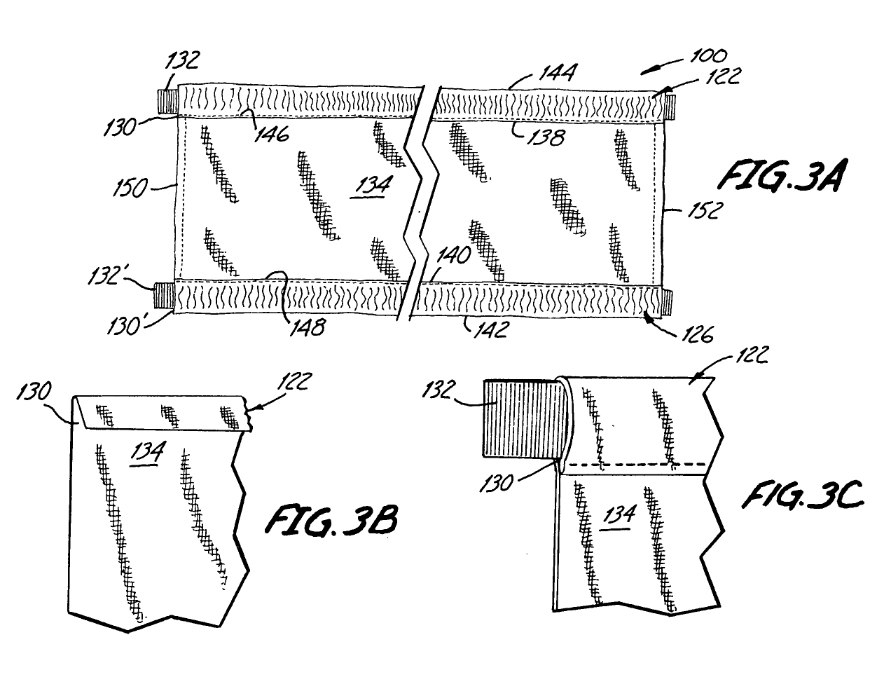

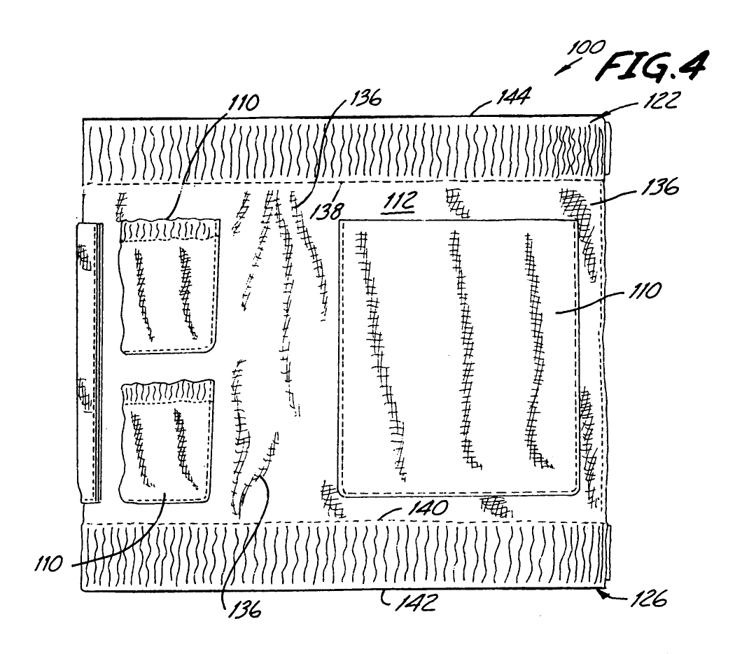

In a preferred embodiment of the present invention, the device 100 is formed by a single length of fabric or netting (e.g. approximately 63″), as shown in FIGS. 3a, 3b, and 3c, with both top and bottom horizontal edges folded over (1.75″) and sewn in place using a ½″ seam allowance to form a housing 130 (of 1.25″) for a 1″ length of non-roll elastic 132 to be threaded therein. The elastic 132 is threaded into an opening of the housing 130 and completely through the housing 130 to match with edges of the fabric. Because the fabric length is greater than the length of the 1″ non-roll elastic 132 threaded therein, the result is that the fabric gathers along the length of the elastic 132 (see fabric gathering lines 136 in FIG. 4). The fabric is then joined at the left and right vertical edges 150,152 and sewn from top to bottom forming a closed seam 128 and thus a tubular-shaped device 100. The inside receiving/holding area, i.e. the longitudinal opening 118, formed within the tubular device 100 by an interior wall 134, can be adjusted by stretching the elastic 132 within the housing 130. The tubular-shaped device 100 with an elasticized horizontal edge both at the top 122 and the bottom 126 is then slid over the seat back section 102 of the passenger seat 104 and positioned so that the bottom horizontal edge of the device 100 is touching the seat section 114 of the passenger seat 104 at the juncture 116 where the seat back section 102 connects to the seat section 114. The holding area 118 can also be used to restrain and/or store a larger sized cargo item, such as a larger sized bottle, purse, etc.

To implement the preferred embodiment of the device 100, a fabric material is laid out with the reverse side of the material facing up, with the length, for example, approximately 63″, running horizontally as shown in FIG. 3a.

Next, a top horizontal edge 138 and a bottom horizontal edge 140 are folded over, and the reverse side of the material touch reverse side of material approximately ½″. A bottom folded edge 142 forms a bottom edge of the housing 130, and a top folded edge 144 forms a top edge of the housing 130. The material is measured approximately 1½″ from the folded edges 142, 144 of the top and bottom horizontal edges 140, 138, respectively, of the material and folded over reverse side to reverse side. The top housing 130 for the top elastic 132 is comprised of two folded horizontal edges 138, 144. A bottom housing 130′ for a bottom elastic 132′ is comprised of two folded horizontal edges 140, 142. A horizontal seam 146, 148 is sewn %″ from the edge 144, 142, respectively, of the housing 130 permanently joining the material and creating the housing 130.

FIG. 3c shows a length of the elastic 132, e.g. approximately 41″, threaded into the opening of the housing 130 and completely through the horizontal length of the housing 130 to match a vertical side of the elastic 132 with a vertical side of the housing 130 and temporarily secured in this position. The use of a length of the elastic 132 which is significantly shorter than the length of the housing 130 results in gathering lines 136 of material along the top and bottom horizontal edges 138, 140 of the device 100 as shown in FIG. 4. Referring to FIG. 4, the vertical edge 150 of the material is then folded over to match with the vertical edge 152 of the material, and the seam 128 is sewn ½″ from the edge 138 at the top to the edge 140 at the bottom of the material securing the elastic 132 in the seam 128.

In FIG. 5, the device 100 is turned inside out to show a finished and joining seam 128 properly in place, thereby forming a single unit. The seam 128 forms the longitudinal opening 118 (in FIG. 2) extending from the top 122 of the device 100 to the bottom 126 of the device 100. The initial height (from the top horizontal edge to the bottom horizontal edge) of the device 100 is approximately 17″, and the finished height of the device 100 is approximately 13.5″. Accordingly, the device 100 can be wrapped around the passenger seat 104 and is held in place against the passenger seat 104 with tensile stress.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

1. A cargo restraint and storage device, adapted to be slid over and onto a seat back section of a passenger seat of a vehicle, comprising:
a piece of fabric material having an opening for receiving at least a portion of the seat back section of the passenger seat; and
wherein the piece of fabric material includes a plurality of pockets for storing varying shapes and sizes of a cargo item, restraining the cargo item from flying out of the passenger seat when a vehicle is in motion, and being accessible to a driver of the vehicle.

2. The device of claim 1, wherein the fabric material is a soft, flexible and lightweight textile such that a passenger can sit comfortably on the passenger seat without removing the fabric material from the seat back section.

3. The device of claim 1, wherein the fabric material is configured to provide strength and restraint against forward and sideways thrust of the cargo item contained therein, while offering flexibility necessary to accommodate varying shapes and sizes of the cargo item.

4. The device of claim 1, wherein the fabric material includes a wall-shaped material forming the opening for sliding over and onto the seat back section.

5. The device of claim 4, wherein the wall-shaped material includes an elasticized top section which is stretchable horizontally, and an elasticized bottom section which is stretchable horizontally, so that when the material is pulled over and onto the passenger seat, tensile stress helps tighten the material onto the passenger seat.

6. The device of claim 5, wherein sides of the fabric material are sewn together to form a single piece.

7. The device of claim 6, wherein top and bottom horizontal edges of the fabric material are folded over and sewn in place, which provides an allowance to form a housing for receiving an elastic.

8. The device of claim 7, wherein the elastic is threaded into and through the housing to match with the sides of the fabric material, wherein a length of the fabric material that the elastic is sewn on is greater than a length of the elastic, thereby forming fabric gatherings along the fabric material.

9. The device of claim 1, wherein the cargo item includes at least one of a purse, a file, a bottle.

10. A cargo restraint and storage device, comprising:
a piece of fabric material; and
means for restraining varying shapes and sizes of a cargo item therein.

11. The device of claim 10, wherein the fabric material is a soft, flexible and lightweight textile.

12. The device of claim 10, wherein the fabric material is configured to provide strength and restraint against forward and sideways thrust of the cargo item contained therein, while offering flexibility necessary to accommodate varying shapes and sizes of the cargo item.

13. The device of claim 10, wherein the fabric material is a wall-shaped material forming an opening.

14. The device of claim 13, wherein the restraining means comprises:
an elasticized top section of the fabric material which is stretchable horizontally, wherein a top edge of the elasticized top section is folded over and sewn in place which provides an allowance to form a housing for receiving an elastic;
an elasticized bottom section of the fabric material which is stretchable horizontally, wherein a bottom edge of the elasticized top section is folded over and sewn in place which provides an allowance to form a housing for receiving an elastic;
at least two sides of the fabric material being sewn together; and
wherein each of the elastics is threaded into and through the respective housing to match with the two sides of the fabric material, wherein a length of the fabric material that the respective elastic is sewn on is greater than a length of the respective elastic, thereby forming fabric gatherings along the fabric material.

15. The device of claim 10, wherein the cargo item includes at least one of a purse, a file, a bottle.

16. A method of using a cargo restraint and storage device having a piece of flexible material with a longitudinal opening, comprising:
pulling a bottom edge of the flexible material, along the longitudinal opening, over and onto a seat back section of a front passenger seat of a vehicle; and
storing and restraining at least one cargo item into one of a plurality of pockets of the flexible material.

17. The method of claim 16, further comprising:
accessing the cargo item by a driver of the vehicle while driving.

18. The method of claim 16, further comprising:
sitting on the front passenger seat without removing the flexible material from the back seat section.

19. The method of claim 16, further comprising:
removing the cargo item from the respective pocket; and
sitting on the passenger seat without removing the fabric material from the back seat section.

20. The method of claim 16, further comprising:
removing the flexible material from the back seat section.
